(19) United States
(12) Patent Application Publication
(10) Pub. No.: US 2015/0272389 A1
(43) Pub. Date: Oct. 1, 2015

(54) Grill Drip Guard Device

(71) Applicant: Robert Roche, Antioch, CA (US)

(72) Inventor: Robert Roche, Antioch, CA (US)

(21) Appl. No.: 14/224,232

(22) Filed: Mar. 25, 2014

(51) Int. Cl. A47J 37/07

(52) U.S. Cl. CPC A47J 37/0786

(57) ABSTRACT

A grill drip guard device prevents drips from soiling a front panel of a grill. The device includes a plate having a first edge, a second edge, and a pair of lateral side edges extending between the first edge and the second edge. A connection flange is coupled to and extends from the first edge of the plate. A coupler is coupled to and extends along the connection flange for coupling the plate to a grill such that the plate extends outwardly from the grill, the second edge of the plate is positioned in spaced relationship to the grill, and the plate extends over a front panel of the grill.

### BACKGROUND OF THE DISCLOSURE

### Field of the Disclosure

The disclosure relates to drip guard devices and more particularly pertains to a new drip guard device for preventing drips from soiling a front panel of a grill.

### SUMMARY OF THE DISCLOSURE

An embodiment of the disclosure meets the needs presented above by generally comprising a plate having a first edge, a second edge, and a pair of lateral side edges extending between the first edge and the second edge. A connection flange is coupled to and extends from the first edge of the plate. A coupler is coupled to and extends along the connection flange for coupling the plate to a grill such that the plate extends outwardly from the grill, the second edge of the plate is positioned in spaced relationship to the grill, and the plate extends over a front panel of the grill.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF THE DRAWINGS

The disclosure will be better understood and objects other than those set forth above will become apparent when consideration is given to the following detailed description thereof. Such description makes reference to the annexed drawings wherein:

FIG. 1 is a bottom back side perspective view of a grill drip guard device according to an embodiment of the disclosure.

FIG. 2 is a side view of an embodiment of the disclosure.

FIG. 3 is a front view of an embodiment of the disclosure.

FIG. 4 is a side view of an embodiment of the disclosure in use.

### DESCRIPTION OF THE PREFERRED EMBODIMENT

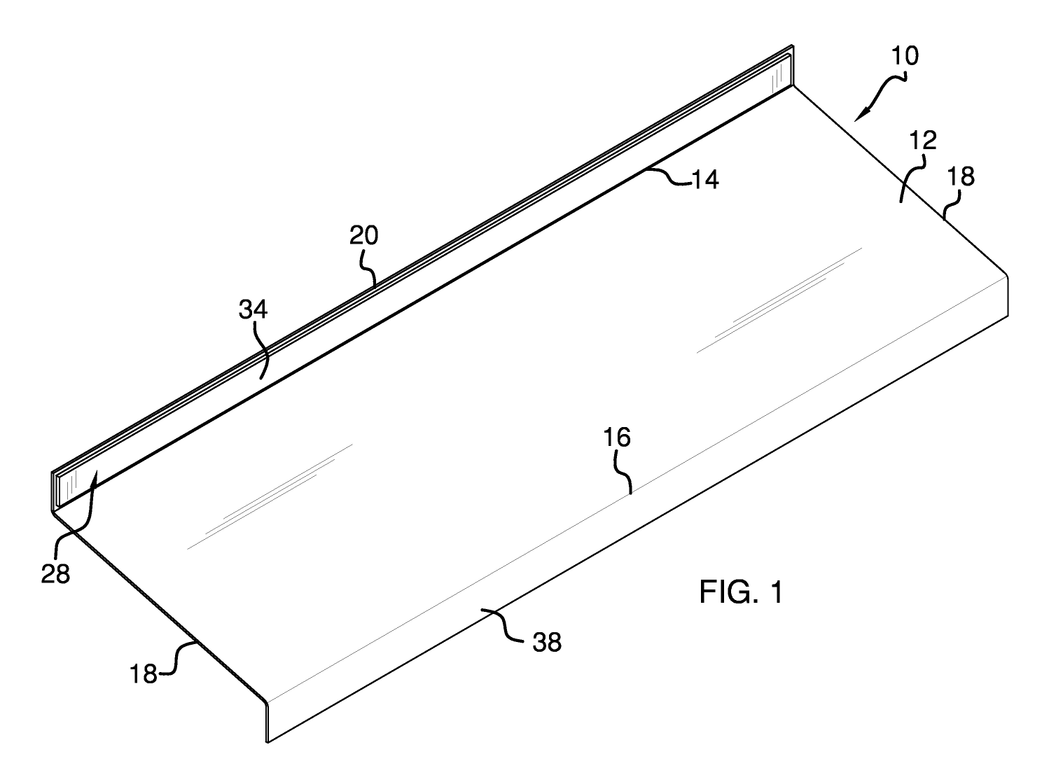

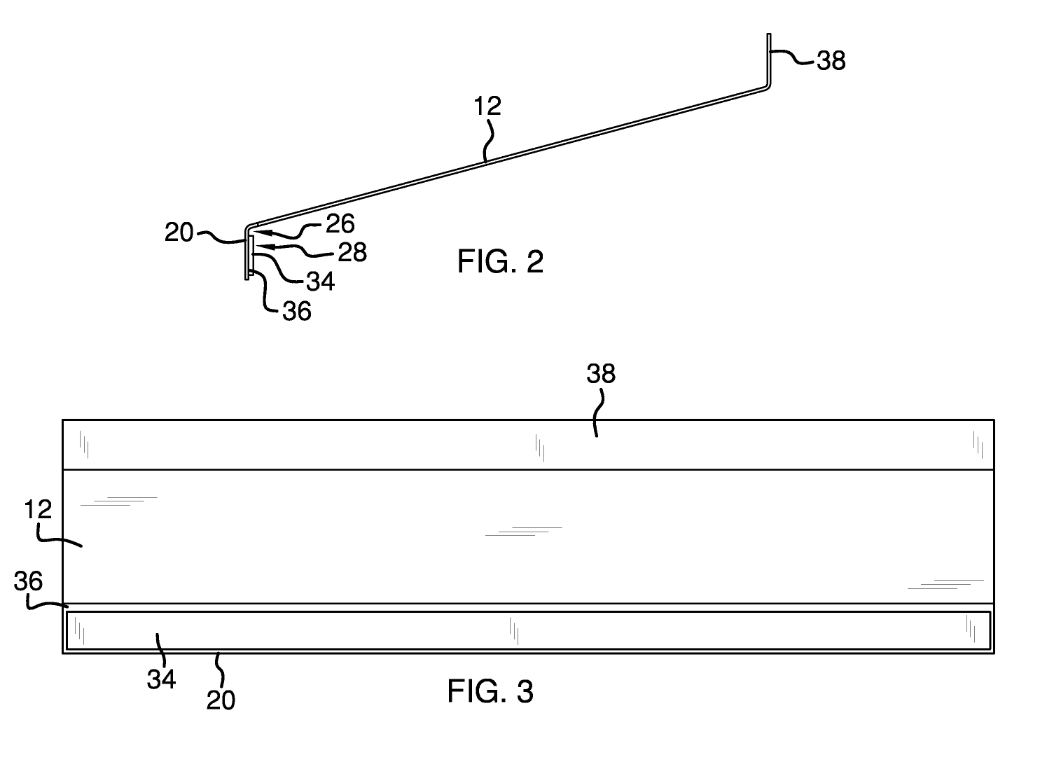

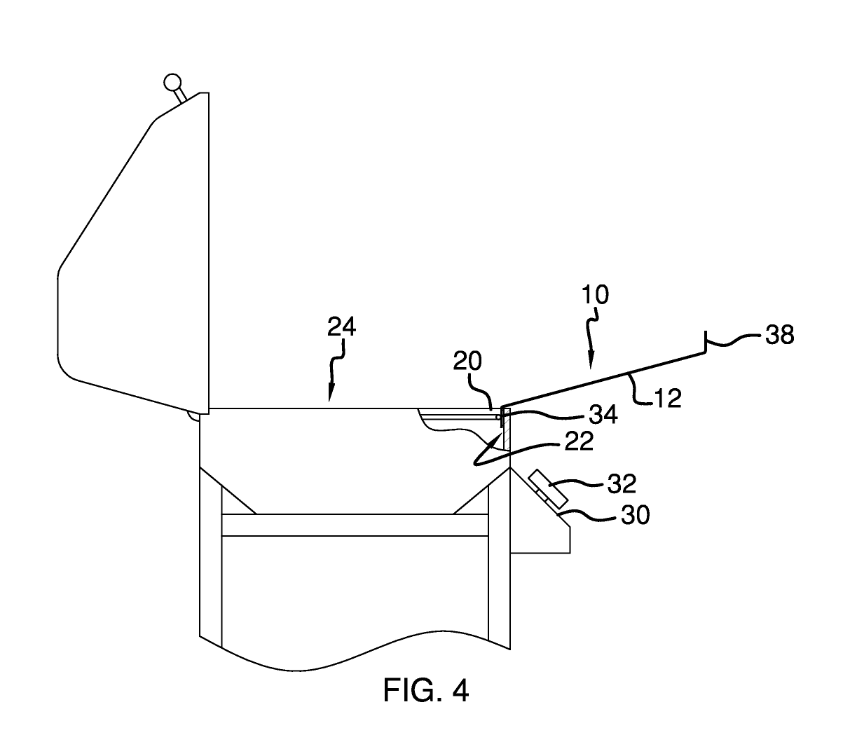

With reference now to the drawings, and in particular to FIGS. 1 through 4 thereof, a new drip guard device embodying the principles and concepts of an embodiment of the disclosure and generally designated by the reference numeral 10 will be described.

As best illustrated in FIGS. 1 through 4, the grill drip guard device 10 generally comprises a plate 12 having a first edge 14, a second edge 16, and a pair of lateral side edges 18 extending between the first edge 14 and the second edge 16. The plate 12 is constructed of stainless steel or the like. A connection flange 20 is coupled to and extends from the first edge 14 of the plate 12. The connection flange 20 is planar to abut against an inward face 22 of a grill 24 adjacent to a cooking surface. The connection flange 20 forms an obtuse angle 26 with the plate 12 such that the plate 12 extends upwardly and outwardly away from the connection flange 20 wherein the plate 12 is configured to receive drips falling onto the plate 12. Angling of the plate 12 allows gravity to urge the drips to fall back towards the grill 24. The connection flange 20 may be an integral extension of the plate 12. A coupler 28 is coupled to and extends along the connection flange 20 wherein the plate 12 is configured for being coupled to the grill 24 such that the plate 12 extends outwardly from the grill 24. When coupled to the grill 24, the second edge 16 of the plate 12 is positioned in spaced relationship to the grill 24 and the plate 12 extends over a front panel 30 of the grill 24. Thus, the plate 12 prevents drips from falling onto the front panel 30 including any knobs 32 or the like positioned on the front panel 30. The coupler 28 may be a magnet 34 coupled to a face 36 of the connection flange 20 facing towards the plate 12. Thus, the connection flange 20 shields the magnet 34 as drips move downwardly on the plate 12 towards the grill 24.

An outer flange 38 is coupled to and extends from the second edge 16 of the plate 12. The outer flange 38 may be parallel to the connection flange 20. The outer flange 38 extends upwardly and outwardly away from the second edge 16 of the plate 12. The outer flange 38 may also be an integral extension of the plate 12.

In use, the device 10 is coupled to extend across the grill 24 covering the front panel 30 while the grill 24 is used. The plate 12 protects the front panel 30 during basting of food on the grill 24 with sauces and/or movement of food to and from the grill 24 over the front panel 30. The device 10 may be removed from the grill and provides flat stainless steel surfaces which are easily cleaned.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A grill drip guard device comprising:
a plate having a first edge, a second edge, and a pair of lateral side edges extending between said first edge and said second edge;
a connection flange coupled to and extending from said first edge of said plate; and
a coupler coupled to and extending along said connection flange wherein said plate is configured for being coupled to a grill such that said plate extends outwardly from said grill wherein said second edge of said plate is positioned in spaced relationship to the grill and said plate extends over a front panel of the grill.

2. The device of claim 1, said connection flange being planar, said connection flange forming an obtuse angle with said plate such that said plate extends upwardly and outwardly away from said connection flange wherein said plate is configured to receive drips falling onto said plate such that gravity urges the drips to fall towards the grill.

3. The device of claim 2, further comprising said coupler being a magnet.

4. The device of claim 3, further comprising said magnet being coupled to a face of said connection flange facing towards said plate.

5. The device of claim 1, further comprising an outer flange coupled to and extending from said second edge of said plate.

6. The device of claim 5, further comprising said outer flange being parallel to said connection flange.

7. The device of claim 6, further comprising said outer flange extending upwardly and outwardly away from said second edge of said plate.

8. The device of claim 1, further comprising said connection flange being an integral extension of said plate.

9. The device of claim 8, further comprising said plate being constructed of stainless steel.

10. A grill drip guard device comprising:
a plate having a first edge, a second edge, and a pair of lateral side edges extending between said first edge and said second edge, said plate being constructed of stainless steel;
a connection flange coupled to and extending from said first edge of said plate, said connection flange being planar, said connection flange forming an obtuse angle with said plate such that said plate extends upwardly and outwardly away from said connection flange wherein said plate is configured to receive drips falling onto said plate such that gravity urges the drips to fall towards the grill, said connection flange being an integral extension of said plate;
a coupler coupled to and extending along said connection flange wherein said plate is configured for being coupled to a grill such that said plate extends outwardly from said grill wherein said second edge of said plate is positioned in spaced relationship to the grill and said plate extends over a front panel of the grill, said coupler being a magnet, said magnet being coupled to a face of said connection flange facing towards said plate; and
an outer flange coupled to and extending from said second edge of said plate, said outer flange being parallel to said connection flange, said outer flange extending upwardly and outwardly away from said second edge of said plate, said outer flange being an integral extension of said plate.
